(19) United States
(12) Patent Application Publication
(10) Pub. No.: US 2019/0227666 A1
(43) Pub. Date: Jul. 25, 2019

(54) TOUCH SCREEN DEVICE AND CONTROL METHOD THEREFOR

(71) Applicant: KORTEK CORPORATION, INCHEON (KR)

(72) Inventors: Son Ou LEE, Seoul (KR); Sang Su KIM, Incheon (KR); Tae Heon NOH, Incheon (KR); Hyeoung Kyu CHANG, Incheon (KR); IL GOOK CHO, Incheon (KR); Woo HWANGBO, Yongin-si (KR)

(21) Appl. No.: 16/333,603

(22) PCT Filed: Aug. 9, 2017
(86) PCT No.: PCT/KR2017/008639

§ 371 Date: Mar. 15, 2019

(30) Foreign Application Priority Data
Oct. 7, 2016 (KR) 10-2016-0130133

(51) Int. Cl. G06F 3/041; G06F 3/0488

(52) U.S. Cl. CPC G06F 3/0416; G06F 3/044; G06F 3/04886

(57) ABSTRACT

A touch screen device and a control method therefor is provided. The touch screen device includes: a touch screen which is mounted on a monitor for displaying an image input from a plurality of image interfaces, on divided screens through a divided screen synthesizer so as to receive an input touch state; a touch control unit for selecting a matching touch interface from among a plurality of touch interfaces on the basis of division information of divided screens with respect to touch coordinates input from the touch screen, and converting the touch coordinates into absolute coordinates for the matching touch interface; and a touch output unit for outputting absolute coordinates to a matching touch interface by the touch control unit.

### CROSS-REFERENCE TO RELATED APPLICATIONS

This application claims priority to PCT Application No. PCT/KR2017/008639, having a filing date of Aug. 9, 2017, based on KR 10-2016-0130133, having a filing date of Oct. 7, 2016, the entire contents both of which are hereby incorporated by reference.

### FIELD OF TECHNOLOGY

The following relates to a touch screen device and a method of controlling the same, and more particularly, to a touch screen device which converts touch coordinates into absolute coordinates of a corresponding one of divided screens and transmits the converted absolute coordinates through an interface of the corresponding divided screen in order to replace a plurality of touch screen devices mounted in individual monitors with a single touch screen device, when physical monitors are replaced with the divided screens of a single monitor having multiple interfaces so as to reduce the number of the physical monitors while maintaining the number of logical screens, in a multi-monitor system in which many monitors are used, such as a button deck, a main, a topper, etc., in one system, such as a casino slot machine, and a method of controlling the same.

### BACKGROUND

Generally, devices associated with multiple monitors include monitor routers, monitor distributors, and keyboard/video monitor/mouse (KVM) switches.

A monitor router is a multi-input one-output device used when a user desires to output an image to a monitor by arbitrarily selecting a personal computer (PC) main body for outputting the image by a button or a remote controller and is used to use a plurality of PCs as a single monitor.

A monitor distributor is a one-input multi-output device used to distribute one screen of an output image of one PC to several monitors at the same time.

A KVM switch is a bi-directional device in which a keyboard/mouse is added to a monitor router and which transmits an output image of a selected PC to a monitor and transmits an input from a keyboard/mouse to the selected PC. In the KVM switch, several PC main bodies, one monitor, and a keyboard/mouse are used.

On the other hand, in the case of a digital image monitoring system used together with a closed-circuit television (CCTV) camera, multi-channel images input from a plurality of CCTV cameras are internally combined to form divided screens and output the images to a single monitor. To this end, a device for generating a full screen composed of divided screens by combining multiple videos regardless of multiple monitors is used.

As the related art, there is Korean Patent No. 10-0748111 (published on Aug. 3, 2007) that is titled “MULTI-CONTROL MONITOR.”

### SUMMARY

The conventional multi-control monitor can be viewed as a combination of a monitor router and a digital image monitoring system. Basically, the multi-control monitor is composed of several personal computer (PC) main bodies, one monitor, and one touch screen. In this case, images of several PC main bodies are displayed on divided screens in the monitor or an image of a specific PC main body selected by a switch is displayed on the monitor.

In the case of a general touch screen, touch processing is performed in a PC main body. On the other hand, in the case of a multi-control monitor, touch screen processing is performed inside the monitor, and thus touch coordinates are not transmitted to the PC main body and control commands, such as turning on/off and the like, for external devices connected thereto are transmitted only to the monitor regardless of the PC main body. Therefore, such a multi-control monitor is in use for special purposes only in special control system environments.

Further, a device such as a digital image monitoring system in which multi-channel images input from a plurality of CCTV cameras are internally combined to form divided screens and generate one image and output the image to a single monitor exits in the form of many products.

However, in one system having a single PC main body, such as a casino slot machine, there is no monitor product which has several image input interfaces and displays individual input images on divided screens of one large monitor in order to replace several monitors which operate simultaneously. As several monitors are integrated into one large monitor, when touch screens mounted on the several monitors are replaced with one large touch screen, there is a problem in that it is not possible to provide user touch interfaces provided by the several monitors in one large touch screen.

The embodiments are directed to providing a touch screen device which converts touch coordinates into absolute coordinates of a corresponding one of the divided screens and transmits the converted absolute coordinates through an interface of the corresponding divided screen in order to replace a plurality of touch screen devices mounted in individual monitors with a single touch screen device when physical monitors are replaced with the divided screens of a single monitor having multiple interfaces so as to reduce the number of the physical monitors while maintaining the number of logical screens in a multi-monitor system in which many monitors are used in one system, and a method of controlling the same.

One aspect of embodiments of the present invention provides a touch screen device which includes a touch screen mounted on a monitor configured to display an image input from a plurality of image interfaces on divided screens through a divided screen synthesizer so as to receive an input touch state, a touch control unit configured to select a matching touch interface from among a plurality of touch interfaces on the basis of division information of the divided screens with respect to touch coordinates input from the touch screen and to convert the touch coordinates into absolute coordinates for the matching touch interface, and a touch output unit configured to output the absolute coordinates to the matching touch interface by the touch control unit.

In embodiments of the present invention, the touch screen may be any one of touch screens in a resistive film type, a surface capacitive (SCAP) type, a projected capacitive (PCAP) type, a surface acoustic wave (SAW) type, an infrared type, and a camera type.

In embodiments of the present invention, the division information may include at least one of the number of screens, a position and a size of each screen, rotation information, and a resolution of the screen, and is dynamically changeable.

In embodiments of the present invention, the touch output unit may include a plurality of output interfaces each connected to a corresponding one of the plurality of touch interfaces.

In embodiments of the present invention, the output interfaces may be at least one of Universal Serial Bus (USB), serial communication, and Inter-Integrated Circuit (I²C).

In embodiments of the present invention, the plurality of touch interfaces and the plurality of image interfaces may be disposed in one or more controllers.

Another aspect of embodiments of the present invention provides a method of controlling a touch screen device which includes receiving, by a touch control unit, touch coordinates from a touch screen which is mounted on a monitor on which images input from a plurality of image interfaces are synthesized and displayed on divided screens through a divided screen synthesizer; setting, by the touch control unit, a touch region of the touch coordinates on the basis of division information of the divided screens; calculating, by the touch control unit, relative coordinates in the touch region with respect to the touch coordinates; calculating, by the touch control unit, absolute coordinates of a touch interface matching the touch region among a plurality of touch interfaces with respect to the relative coordinates on the basis of the division information; and outputting, by the touch control unit, the absolute coordinates to the matching touch interface through a touch output unit.

In embodiments of the present invention, the touch screen may be any one of touch screens in a resistive film type, a SCAP type, a PCAP type, a SAW type, an infrared type, and a camera type.

In embodiments of the present invention, the division information may include at least one of the number of screens, a position and a size of each screen, rotation information, and a resolution of the screen, and is dynamically changeable.

In embodiments of the present invention, the touch output unit may include a plurality of output interfaces each connected to a corresponding one of the plurality of touch interfaces.

In embodiments of the present invention, the output interfaces may be at least one of USB, serial communication, and I²C.

In embodiments of the present invention, the plurality of touch interfaces and the plurality of image interfaces may be disposed in one or more controllers.

According to a touch screen device and a method of controlling the same according to exemplary embodiments of the present invention, in a multi-monitor system in which many monitors are used in one system, physical monitors are replaced with divided screens of a single monitor having multiple interfaces so as to reduce the number of the physical monitors while maintaining the number of logical screens, several touch screen devices mounted in individual monitors are replaced with a single touch screen device, and touch coordinates are converted into absolute coordinates of a corresponding one of the divided screens and the absolute coordinates are transmitted through an interface of the corresponding divided screen. Therefore, it is possible to support a touch function of divided screens displayed on one monitor, it is possible to reduce molding costs of monitor devices and manufacturing costs of touch screens, and it is possible to provide a more elegant user screen through logical screens connected continuously without a bezel.

### BRIEF DESCRIPTION

Some of the embodiments will be described in detail, with reference to the following figures, wherein like designations denote like members, wherein:

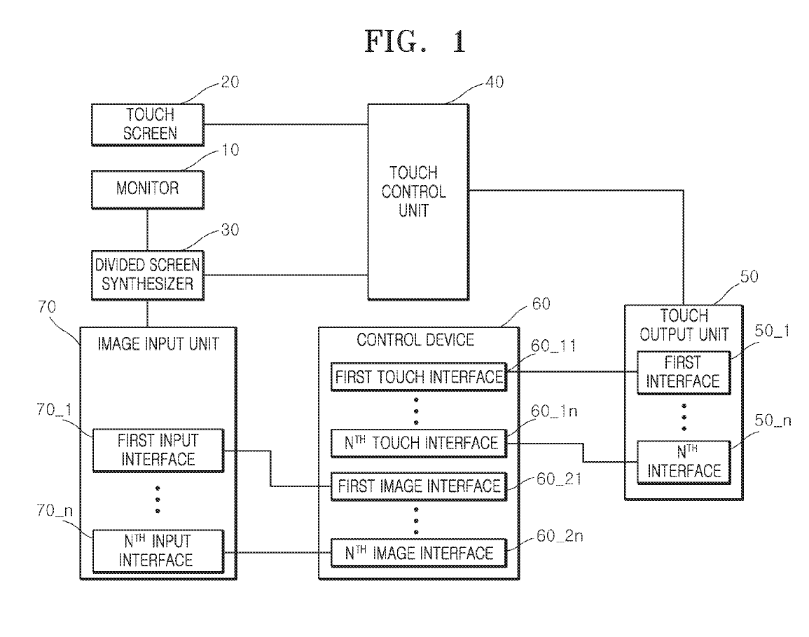

FIG. 1 is a block diagram showing a touch screen device according to exemplary embodiments of the present invention;

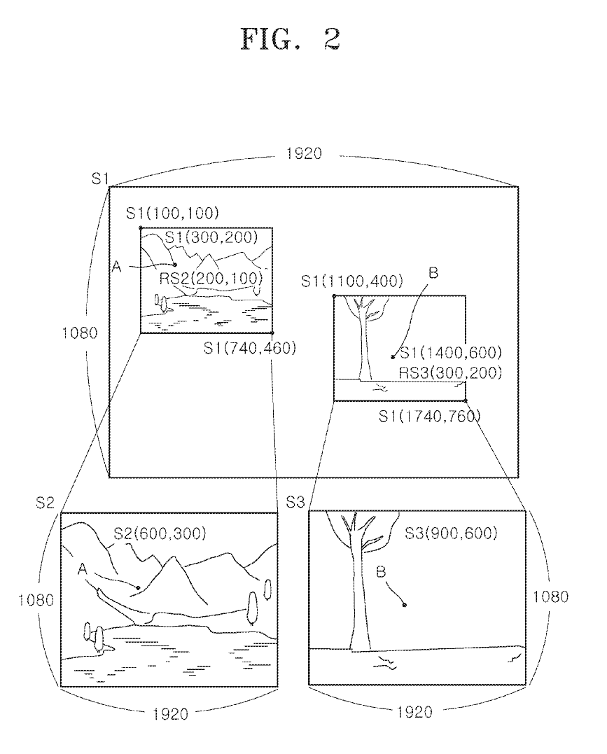

FIG. 2 is a view for describing a conversion process of the touch screen device according to the exemplary embodiments of the present invention; and

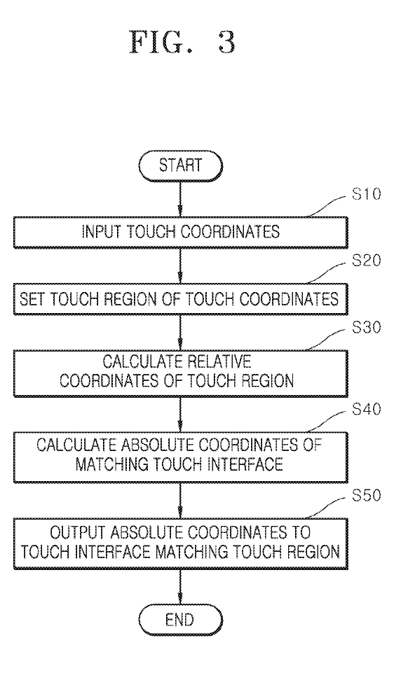

FIG. 3 is a flowchart for describing a method of controlling a touch screen device according to exemplary embodiments of the present invention.

### DETAILED DESCRIPTION

Hereinafter, a touch screen device and a method of controlling the same according to embodiments of the present invention will be described with reference to the accompanying drawings. In this process, thicknesses of lines, sizes of components, and the like illustrated in the drawings may be exaggerated for clarity and convenience of description. In addition, some terms which will be described below are defined in consideration of functions in embodiments of the present invention and meanings may vary depending on, for example, a user or operator's intentions or customs. Therefore, the meanings of these terms should be interpreted based on the scope throughout this specification.

FIG. 1 is a block diagram showing a touch screen device according to exemplary embodiments of the present invention, and FIG. 2 is a view for describing a conversion process of the touch screen device according to the exemplary embodiments of the present invention.

Referring to FIG. 1, the touch screen device according to the exemplary embodiments of the present invention includes a touch screen 20, a touch control unit 40, and a touch output unit 50.

The touch screen 20 is installed on a front surface of a monitor 10 on which images input from first to n^{th} image interfaces 60_21 to 60_2n of a control device 60 are generated on divided screens through a divided screen synthesizer 30 to be displayed on one screen, and the touch screen 20 receives a touch state.

Here, the control device 60 may refer to one personal computer (PC) or several PCs. That is, the first to n^{th} image interfaces 60_21 to 60_2n and first to n^{th} touch interfaces 60_11 to 60_1n are disposed in a single PC or several PCs.

In the present embodiment, the touch screen 20 is any one of touch screens in a resistive film type, a surface capacitive (SCAP) type, a projected capacitive (PCAP) type, a surface acoustic wave (SAW) type, an infrared type, and a camera type, and is not limited to the touch type but is independent. Any type of touch screen may be applied.

Further, the divided screen synthesizer 30 is a device for outputting images which are input from the first to n^{th} image interfaces 60_21 to 60_2n of the control device 60 respectively connected to the first to n^{th} input interfaces 70_1 to 70_n of the image input unit 70 on one screen as divided screens. The divided screen synthesizer 30 has a commonly used configuration and is not a subject of embodiments of the present invention. The divided screen synthesizer 30 provides division information about generating the divided screens to the touch control unit 40.

In this case, various methods, such as a picture in picture (PIP) method, a picture out picture (POP) method, a picture by picture (PBP) method, and the like may be used for the divided screens. The embodiments are not limited to the type of divided screens but is independent.

Further, the division information may include at least one of the number of screens, a position and a size of each screen, rotation information, and a resolution of the screen, and the divided screen synthesizer 30 may dynamically change the division information to generate the divided screens.

For example, as shown in FIG. 2, the divided screen synthesizer 30 may display the images input from the first to n^{th} image interfaces 60_21 to 60_2n of the control device 60 on two sub screens S2 and S3 in one main screen S1 in a PIP method as divided screens and may dynamically change the divided screens.

The touch output unit 50 may output absolute coordinates converted by the touch control unit 40 to the matching touch interface among the plurality of touch interfaces 60_11 to 60_1n and allow the control device 60 which receives the touch coordinates to perform a related control function.

For example, the touch output unit 50 includes first to n^{th} output interfaces 50_1 to 50_n respectively connected to the first to n^{th} touch interfaces 60_11 to 60_1n and outputs the absolute coordinates to any one selected from among the first to n^{th} touch interfaces 60_11 to 60_1n according to the touch state.

Here, the first to n^{th} output interfaces 50_1 to 50_n support at least one of Universal Serial Bus (USB), serial communication, and Inter-Integrated Circuit (I²C) and are not limited to a specific communication method but are independent. The first to n^{th} output interfaces 50_1 to 50_n may output the touch state by using a combination of a plurality of communication methods.

The touch control unit 40 selects the matching touch interface from among the first to n^{th} touch interfaces 60_11 to 60_1n on the basis of the division information input from the control device 60 or the divided screen synthesizer 30 with respect to the touch coordinates input from the touch screen 20, converts the touch coordinates into absolute coordinates of the matching touch interface, and outputs the converted absolute coordinates to the matching touch interface through the touch output unit 50.

For example, as shown in FIG. 2, in the case of the images input from the first to n^{th} image interfaces 60_21 to 60_2n, in a state in which the image of the first image interface 60_21 is displayed on a first screen S1, which is the main screen, through the divided screen synthesizer 30, a second screen S2 and a third screen S3 are divided as sub screens by a PIP method so that the image of the second image interface 60_22 and the image of the third image interface 60_23 may be displayed.

Here, referring to the division information obtained by dividing the images of the first to third image interfaces 60_21 to 60_23 by the divided screen synthesizer 30, resolutions of images input from the first to third image interfaces 60_21 to 60_23 are identical to each other with a resolution of 1920*1080, an image is displayed on the first screen S1 at a ratio of 1:1 with a resolution of 1920*1080, an image is displayed on the second screen S2 or the third screen S3 by being reduced by ⅓ to 640*360, coordinates of an upper left end of the second screen S2 are indicated by (100,100), coordinates of a lower right end of the second screen S2 are indicated by (740,460), coordinates of an upper left end of the third screen S3 are indicated by (1100,400), and coordinates of a lower right end of the third screen S3 are indicated by (1740,760). Further, the second screen S2 and the third screen S3 were not rotated.

In this case, when a point A of the touch screen installed with a resolution of 1920*1080 at a ratio of 1:1 with the first screen is touched, the touch control unit 40 receives touch coordinates S1 (300,200) and sets which touch region of the divided screens includes the touch coordinates S1 (300,200) on the basis of the division information. Here, the touch coordinates S1 (300,200) are coordinates included in a touch region of the second screen S2 so that the touch control unit 40 calculates relative coordinates RS2 (200,100) of the second screen S2 from coordinates (100,100) of the upper left end of the second screen S2.

The touch control unit 40 calculates absolute coordinates S2 (600,300) by reflecting a division ratio according to a resolution of the second screen S2 on the basis of the division information with respect to the relative coordinates of the second screen S2 and outputs the calculated absolute coordinates S2 (600,300) to the second touch interface 60_12 matching the second screen S2 through the touch output unit 50 to recognize the touch state.

Meanwhile, when a point B of the touch screen 20 is touched, the touch control unit 40 receives touch coordinates S1 (1400,600) and determines whether the touch coordinates S1 (1400,600) are included in the touch region of the divided screens on the basis of the division information.

Here, the touch coordinates S1 (1400,600) are coordinates included in a touch region of the third screen S3 so that the touch control unit 40 calculates relative coordinates RS3 (300,200) of the third screen S3 from the coordinates (1100,400) of the upper left end of the third screen S3.

The touch control unit 40 calculates absolute coordinates S3 (900,600) by reflecting a division ratio according to the resolution of the third screen S3 on the basis of the division information with respect to the relative coordinates of the third screen S3 and outputs the calculated absolute coordinates S3 (900,600) to the third touch interface 60_13 matching the third screen S3 through the touch output unit 50 to recognize the touch state.

In the present embodiment, a ratio of a screen resolution of the image to a touch resolution of the touch screen 20 is described as being set to 1:1 for ease of explanation. However, the touch resolution is actually a separate logical resolution different from the screen resolution. Therefore, actually, the matching should be performed in an independent method with respect to a ratio difference between the screen resolution and the touch resolution. Such a method is a known method and is not a subject of embodiments of the present invention, and therefore, this method is not described in detail in the present embodiment.

As described above, according to the touch screen device according to the exemplary embodiments of the present invention, in a multi-monitor system in which many monitors are used in one system, physical monitors are replaced with divided screens of a single monitor having multiple interfaces so as to reduce the number of the physical monitors while maintaining the number of logical screens, several touch screen devices mounted in each of the monitors are replaced with a single touch screen device, and touch coordinates are converted into absolute coordinates of a corresponding one of the divided screens and the absolute coordinates are transmitted through an interface of the corresponding divided screen. Therefore, it is possible to support a touch function of divided screens displayed on one monitor, it is possible to reduce molding costs of monitor devices and manufacturing costs of touch screens, and it is possible to provide a more elegant user screen through logical screens connected continuously without a bezel.

FIG. 3 is a flowchart for describing a method of controlling a touch screen device according to exemplary embodiments of the present invention.

As shown in FIG. 3, according to the method of controlling the touch screen device according to the exemplary embodiments of the present invention, first, a touch control unit 40 receives touch coordinates from a touch screen 20 which is mounted on a front surface of a monitor 10 on which images input from first to n^{th} image interfaces 60_21 to 60_2n are synthesized and displayed on divided screens through a divided screen synthesizer 30 (S10).

Here, the touch screen 20 is installed on the front surface of the monitor 10 on which the images input from the first to n^{th} image interfaces 60_21 to 60_2n are synthesized and displayed as the divided screens through the divided screen synthesizer 30. The touch screen 20 may be any one of touch screens in a resistive film type, a SCAP type, a PCAP type, a SAW type, an infrared type, or a camera type and is not limited to the touch type but is independent. Any type of touch screen may be applied as the touch screen 20.

As shown in FIG. 2, when a point A of the touch screen 20 installed with a resolution of 1920*1080 at a ratio of 1:1 with a first screen S1 is touched, the touch control unit 40 receives touch coordinates S1 (300,200) (S10).

The touch control unit 40 sets which touch region of the divided screens includes the touch coordinates S1 (300,200), which is received in operation S10, on the basis of the division information received from the control device 60 or the divided screen synthesizer 30 (S20).

In this case, the division information may include at least one of the number of screens, a position and a size of each screen, rotation information, and a resolution of the screen, and may be dynamically changeable.

Here, the touch coordinates S1 (300,200) at the point A are coordinates included in coordinates (100,100) of an upper left end of a second screen S2 and coordinates (740,460) of a lower right end of the second screen S2, and a touch region may be set to the touch region of the second screen S2.

After the touch region is set in operation S20, the touch control unit 40 calculates relative coordinates RS2 (200,100) of the second screen S2 from coordinates (100,100) of the upper left end of the second screen S2 with respect to the touch coordinates S1 (300,200) (S30).

After the relative coordinates RS2 (200,100) of the second screen S2 are calculated in operation S30, the touch control unit 40 calculates absolute coordinates S2 (600,300) by reflecting a division ratio according to a resolution of the second screen S2 on the basis of the division information (S40).

The touch control unit 40 outputs the absolute coordinates S2 (600,300) calculated in operation S40 to a second touch interface 60_12 matching the second screen S2 through a second output interface 50_2 of the touch output unit 50 to recognize a touch state (S50).

Here, the second output interface 50_2 supports at least one of USB, serial communication, and I²C, and is not limited to a specific communication method but is independent. The second output interface 50_2 may output the touch state by using a combination of a plurality of communication methods.

As described above, according to the method of controlling the touch screen device according to the exemplary embodiments of the present invention, in a multi-monitor system in which many monitors are used in one system, physical monitors are replaced with divided screens of a single monitor having multiple interfaces so as to reduce the number of the physical monitors while maintaining the number of logical screens, several touch screen devices mounted in individual monitors are replaced with a single touch screen device, and touch coordinates are converted into absolute coordinates of a corresponding one of the divided screens and the absolute coordinates are transmitted through an interface of the corresponding divided screen. Therefore, it is possible to support a touch function of divided screens displayed on one monitor, it is possible to reduce molding costs of monitor devices and manufacturing costs of touch screens, and it is possible to provide a more elegant user screen through logical screens connected continuously without a bezel.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A touch screen device comprising:
a touch screen mounted on a monitor configured to display an image input from a plurality of image interfaces on divided screens through a divided screen synthesizer to receive an input touch state;
a touch control unit configured to select a matching touch interface from among a plurality of touch interfaces on the basis of division information of the divided screens with respect to touch coordinates input from the touch screen and to convert the touch coordinates into absolute coordinates for the matching touch interface; and
a touch output unit configured to output the absolute coordinates to the matching touch interface by the touch control unit.

2. The touch screen device of claim 1, wherein the touch screen is any one of touch screens in a resistive film type, a surface capacitive (SCAP) type, a projected capacitive (PCAP) type, a surface acoustic wave (SAW) type, an infrared type, and a camera type.

3. The touch screen device of claim 1, wherein the division information includes at least one of a number of screens, a position and a size of each screen, rotation information, and a resolution of the screen, and is dynamically changeable.

4. The touch screen device of claim 1, wherein the touch output unit includes a plurality of output interfaces each connected to a corresponding one of the plurality of touch interfaces.

5. The touch screen device of claim 4, wherein each of the output interfaces is at least one of Universal Serial Bus (USB), serial communication, and Inter-Integrated Circuit (I²C).

6. The touch screen device of claim 1, wherein the plurality of touch interfaces and the plurality of image interfaces are disposed in one or more controllers.

7. A method of controlling a touch screen device, the method comprising:
receiving, by a touch control unit, touch coordinates from a touch screen which is mounted on a monitor on which images input from a plurality of image interfaces are synthesized and displayed on divided screens through a divided screen synthesizer;
setting, by the touch control unit, a touch region of the touch coordinates on the basis of division information of the divided screens;
calculating, by the touch control unit, relative coordinates in the touch region with respect to the touch coordinates;
calculating, by the touch control unit, absolute coordinates of a touch interface matching the touch region among a plurality of touch interfaces with respect to the relative coordinates on the basis of the division information; and
outputting, by the touch control unit, the absolute coordinates to the matching touch interface through a touch output unit.

8. The method of claim 7, wherein the touch screen is any one of touch screens in a resistive film type, a surface capacitive (SCAP) type, a projected capacitive (PCAP) type, a surface acoustic wave (SAW) type, an infrared type, and a camera type.

9. The method of claim 7, wherein the division information includes at least one of a number of screens, a position and a size of each screen, rotation information, and a resolution of the screen, and is dynamically changeable.

10. The method of claim 7, wherein the touch output unit includes a plurality of output interfaces each connected to a corresponding one of the plurality of touch interfaces.

11. The method of claim 10, wherein each of the touch interfaces is at least one of Universal Serial Bus (USB), serial communication, and Inter-Integrated Circuit (I²C).

12. The method of claim 7, wherein the plurality of touch interfaces and the plurality of image interfaces are disposed in one or more controllers.
